(19) United States
(12) Patent Application Publication
(10) Pub. No.: US 2015/0041566 A1
(43) Pub. Date: Feb. 12, 2015

(54) APPARATUS FOR CONTROLLING NEEDLE VALVE LEAKAGE

(71) Applicants: William Yunbiao Shen, Westmont, IL (US); Erik Jordan Hansen, Elgin, SC (US)

(72) Inventors: William Yunbiao Shen, Westmont, IL (US); Erik Jordan Hansen, Elgin, SC (US)

(73) Assignee: International Engine Intellectual Property Company , LLC, Lisle, IL (US)

(21) Appl. No.: 14/396,156

(22) PCT Filed: Apr. 26, 2012
(86) PCT No.: PCT/US12/35205

§ 371 Date: Oct. 22, 2014

(51) Int. Cl. F02M 67/12; F02M 61/12

(52) U.S. Cl. CPC F02M 67/12; F02M 61/12
USPC 239/584

(57) ABSTRACT

A needle body for a fuel injector that controls or prevents high pressure fuel leaks by dynamically controlling the size of the clearance between a longitudinal bore in a nozzle body and the needle that travels along the bore. The longitudinal bore passes through a body portion and a clearance control protrusion of the needle body. The clearance control protrusion extends from the body portion into a nozzle chamber of a nozzle section of the fuel injector. The clearance control protrusion is configured to prevent expansion of the clearance that is typically associated with hydraulic forces caused by pressurized fuel in the clearance. The clearance control protrusion is configured so that as fuel pressure in the nozzle chamber increases, hydraulic forces act against an outer surface of the clearance control protrusion to prevent expansion of the portion of the clearance positioned within the clearance control protrusion.

### BACKGROUND

High-pressure fuel injection systems are often used in combustion engines to deliver fuel, such as diesel fuel or gasoline, to a combustion engine. In such systems, fluid is supplied at high-pressure through a common rail to each of a series of unit fuel injectors within the cylinder head. Each injector includes a valve, such as a needle valve, which controls the release of fuel from the fuel injector. When the needle valve is in an open position, the fuel is forced out of a small opening or outlet in a nozzle assembly of the fuel injector under high pressure, thereby typically atomizing the fuel that is delivered to the combustion chamber of the combustion engine.

Each high-pressure fuel injector has an actuating fluid control valve that is electronically controlled to control the timing and amount of the actuating fluid flowing into the injector. The actuating fluid control valve initiates and terminates the injection process. A representative high-pressure fuel injector has a plunger that is displaced within an internal pressurization chamber by fluid from the rail when an electronically controlled valve in the injector opens in response to a signal from the engine controller. The fluid acts via the plunger to amplify the fuel pressure in the pressurization chamber to a magnitude large enough to force a normally closed valve, such as the needle valve, in the nozzle assembly to open. When the needle valve moves from a closed position, where a needle of the needle valve is seated on a valve seat, to an open position, where the needle is no longer seated on the valve seat, the amplified fuel pressure forces fuel through the outlet of the nozzle assembly and into the combustion chamber. Terminating the control signal to the electronically controlled valve terminates the injection. The needle of the needle valve will then return to its normally closed position, and fluid flows from the rail to refill the pressurization chamber, forcing the plunger to retract in the process.

As the fuel pressure increases in the fuel injector, the fuel injector may experience undesirable fuel leakages. For example, a common rail diesel fuel system may have a nozzle assembly that includes a nozzle body and having a longitudinal bore that is configure to guide the movement of the needle as the needle moves from open and closed positions. In order to prevent the longitudinal bore from interfering with the movement of the needle, the longitudinal bore and/or needle may be configured so that there is sufficient distance or clearance between interior walls of the longitudinal bore and the adjacent portion of the needle. However, as pressure within the nozzle assembly increases, such as for example the pressure beneath the needle guide reaches or exceeds operational fuel pressures of 2000-3000 bar, fuel within the nozzle assembly may be forced into the clearance between the needle and the longitudinal bore. Such pressurized fuel, or additional pressurized fuel, in or entering the clearance may provide a hydraulic force that causes the clearance to expand in size, such as, for example, a 2-3 mm increase in the clearance. Such expansion of the clearance may result in a fuel leak in or from the nozzle assembly, which may cause a decrease in the fuel efficiency and economy of the fuel system.

### SUMMARY

An aspect of the illustrated embodiment is a needle body for the nozzle section of a high pressure fuel injector. The needle body includes a body portion and a clearance control protrusion. The clearance control protrusion is configured to extend from the body portion and into a nozzle chamber of the nozzle section. A longitudinal bore extends through the body portion and the clearance control protrusion. The longitudinal bore has an inner wall that is sized to provide a clearance between the longitudinal bore and a needle of a needle valve that is slideably positioned within the longitudinal bore. Additionally, the clearance control protrusion is configured for hydraulic forces exerted by pressurized fuel in the nozzle chamber against an outer surface of the clearance control protrusion to prevent the expansion of the portion of the clearance that is positioned within the clearance control protrusion.

Another aspect of the illustrated embodiment is a needle body for the nozzle section of a high pressure fuel injector. The needle body includes a body portion and a clearance control protrusion. The clearance control protrusion extends from the body portion. The needle body also includes a longitudinal bore that extends through the body portion and the clearance control protrusion. Further, the clearance control protrusion is configured to control the size of the longitudinal bore along the clearance control protrusion when the needle body is subjected to hydraulic forces at operational fuel pressures in the nozzle chamber of a fuel injector.

Another aspect of the illustrated embodiment is a system for controlling high pressure fuel leak in a fuel injector. The system includes a nozzle body having a nozzle chamber that is configured to receive and contain pressurized fuel. The system also includes a needle valve having a needle, the needle valve being configured to release fuel from the nozzle chamber when the needle is moved from a closed position to an open position. The system further includes a nozzle section that has a body portion, a clearance control protrusion, and a longitudinal bore. The clearance control protrusion has an outer surface. Additionally, the longitudinal bore is configured to guide the movement of the needle as the needle moves between the closed and open positions. The longitudinal bore also has a clearance between an inner wall of the longitudinal bore and an adjacent outer wall of the needle. The clearance control protrusion is configured to prevent the expansion of the clearance along the clearance control protrusion when the outer surface of the clearance control protrusion is subjected to hydraulic forces from the pressurized fuel.

### BRIEF DESCRIPTION OF THE DRAWINGS

FIG. 1 illustrates a cross sectional view of at least a nozzle section of a high pressure fuel injector.

FIG. 2 illustrates a cross sectional view of a portion of a nozzle section for a high pressure fuel injector that has a needle body with a clearance control protrusion.

### DETAILED DESCRIPTION

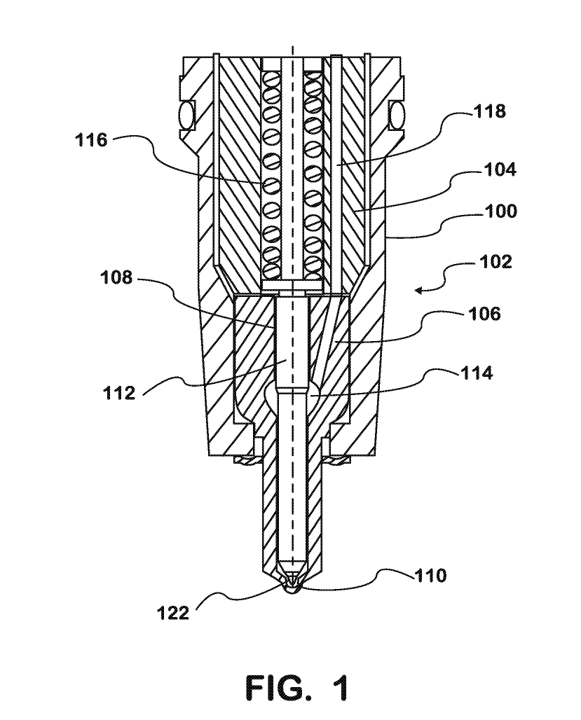

FIG. 1 illustrates a cross sectional view of a portion a high pressure fuel injector 100. High-pressure fuel injectors 100 generally include a nozzle section 102. The nozzle section 102 includes a spring cage 104 and a nozzle body 106. While the spring cage 104 and nozzle body 106 are shown as separate components, they could also be formed as an integral unit. The spring cage 104 and nozzle body 106 define a longitudinal bore 108 that terminates in a nozzle orifice 110. A nozzle valve, such as a needle valve, is configured so that a needle 112 of the needle valve is slideably disposed in the longitudinal bore 108 for movement between a first (closed) position that blocks fluid communication between a nozzle chamber 114 and the orifice 110, and a second (open) position that opens fluid communication between the nozzle chamber 114 and the orifice 110. A coil spring 116 is positioned in the spring cage 104 above the needle valve for normally biasing the needle 112 to its first (closed) position.

During operation, fuel flows through a delivery passage 118 in the spring cage 104 and nozzle body 106 and into the nozzle chamber 114. The fuel pressure in the nozzle chamber 114 acts against the needle valve and forces the needle 112 upwardly against the force of the coil spring 116. Usually, the first pressure wave is sufficient to unseat the needle 112 from the valve seat 122 and begin fuel injection. If the pressure wave is insufficient to lift the needle 112, the pressure build-up that immediately follows will do so. When the needle 112 unseats from the valve seat 122, and moreover the orifice 110, fuel passes through the orifice 110 and is delivered to the associated engine combustion chamber.

The longitudinal bore 108 of the nozzle body 106 may be configured to guide the movement of the needle 112 as the needle 112 moves between open and closed positions. In order to prevent the nozzle bore 108 from interfering with such movement of the needle 112, the nozzle bore 108 may be larger than the outer dimension of the adjacent portion of the needle 112 so as to provide clearance between the nozzle bore 108 and the adjacent portion of the needle 112. For example, if the needle 112 is generally cylindrical in configuration, the nozzle bore 108 may have a diameter that is slightly larger than the adjacent outer diameter of the needle 112.

However, such a clearance may cause fuel to leak from the nozzle body 102 as fuel pressure in the nozzle chamber 114 increases. More specifically, a clearance between the longitudinal bore 108 and the needle 112 provides a space where fuel may enter, such as, for example, a 2-4 m diametrical clearance. As fuel pressure increases in the nozzle chamber 114, additional fuel may be forced into the clearance between the nozzle bore 108 and the needle 112. The increase quantity of pressurized fuel in the clearance may allow for hydraulic forces associated with the additional pressurized fuel to exert a hydraulic force against the clearance that causes the clearance to expand in size. An expansion in the clearance may result additional fuel entering into the clearance, thereby increasing the hydraulic force in the clearance and further expanding the size of the clearance. As the clearance expands in size, the clearance provides a larger pathway that can accommodate larger amounts of fuel traveling along the longitudinal bore 108 and leak out of the nozzle body 106.

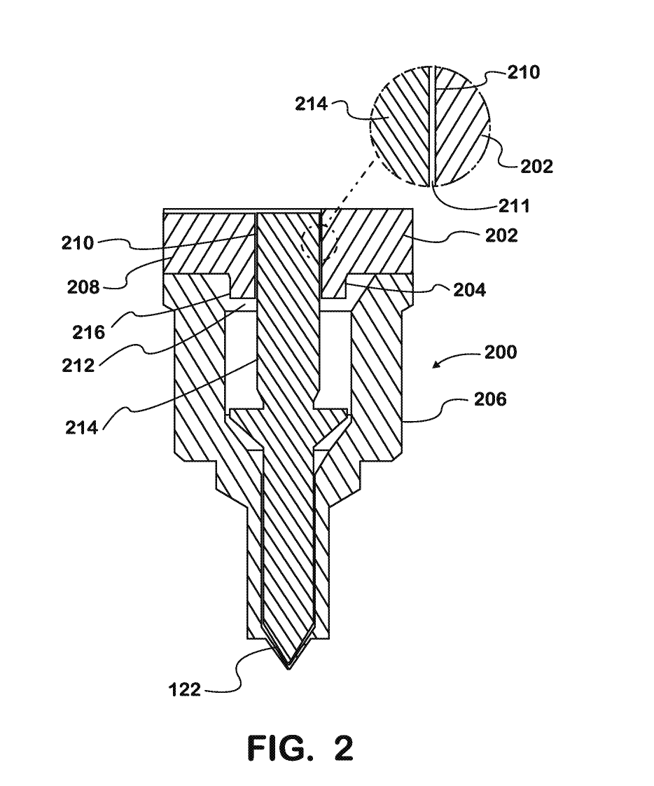

FIG. 2 illustrates a cross sectional view of a portion of a nozzle section 200 for a high pressure fuel injector that has a needle body 202 with a clearance control protrusion 204. As shown, the needle body 202 is positioned adjacent to the nozzle body 206. The needle body 202 includes the clearance control protrusion 204, a body portion 208, and a longitudinal bore 210. As previously discussed, the longitudinal bore 210 is sized to guide the movement of the needle 214 while having sufficient space or clearance 211 between the needle 214 and walls of the bore 210 so as to not interfere with the movement of the needle 214.

The clearance control protrusion 204 generally extends away from the body portion 208 and into the nozzle chamber 212. As shown, the longitudinal bore 210 passes through the clearance control protrusion 204. The control protrusion 204 is configured so that, as fuel pressure increases within at least a portion of the nozzle chamber 212, a hydraulic force from the pressurized fuel adjacent to an outer surface 216 of the control protrusion 204 provides a force against the control protrusion 204 that acts against a generally outwardly directed hydraulic force in the clearance 211. More specifically, as previously discussed, as pressure in the nozzle chamber increases, and pressurized fuel enters or increases in quantity in the clearance 211, a generally outwardly directed hydraulic force from the pressurized fuel may attempt to expand the size of the clearance 211.

The clearance control protrusion 204 may be configured such that hydraulic force from the pressurized fuel in the nozzle chamber 212 outside of, but adjacent to, the clearance control protrusion 204, provides a generally inwardly directed force against the outer surface 216 of the clearance control protrusion 204 that prevents the expansion of the clearance 211 between the longitudinal bore 210 and the needle 212. For example, the clearance control protrusion 204 may be configured such as the wall thickness or wall length of the clearance control protrusion 204, such that the clearance control protrusion 204, may be generally inwardly bent, deformed, or deflected by the hydraulic force of the pressurized fuel outside of the clearance control protrusion 204 so as to reduce at least a portion of the size of the clearance. For example, according to certain embodiments, the clearance control protrusion 204 may have a wall length of about 2-4 mm. Further, the wall thickness may be configured to prevent over-squeeze of the clearance that could interfere with movement of the needle 212. Alternatively, the size and shape of the clearance control protrusion 204 may be sized such that the generally inwardly directed hydraulic force of the pressurized fuel outside of the clearance control protrusion 204 counteracts the generally outwardly directed hydraulic force caused by pressurized fuel in the clearance. By being able to counteract hydraulic forces that attempt to expand the clearance 211, the clearance control protrusion 204 provides dynamic clearance 211 reduction or control as fuel pressure in the nozzle chamber 212 increases. Thus, the clearance control protrusion 204 acts to reduce and/or prevent leakage through the nozzle section, and more specifically, along the clearance 211, as fuel pressure increases.

The clearance control protrusion 204 may have a variety of configurations. For example, the clearance control protrusion 204 may have a variety of different shapes and sizes, including being cylindrical, oval, non-round, rectangular, square, and triangular, among others. Further, the wall thickness of the clearance control protrusion 204, such as the thickness between the longitudinal bore 210 and outer surface 216 may or may not be consistent around or across the clearance control protrusion 204. According to certain embodiments, the wall thickness may be tapered such that the wall thickness decreases as the clearance control protrusion 204 extends away from the body portion 208. Further, the length, wall thickness, and/or shape of the clearance control protrusion 204 may vary depending on the application, including the expected operating fuel pressures in the fuel injector 100.

1. A needle body for the nozzle section of a high pressure fuel injector comprising:
a body portion;
a clearance control protrusion having an outer surface, the clearance control protrusion configured to extend from the body portion and into a nozzle chamber of the nozzle section; and
a longitudinal bore that extends through the body portion and the clearance control protrusion, the longitudinal bore having an inner wall that is sized to provide a clearance between the longitudinal bore and a needle of a needle valve that is slideably positioned within the longitudinal bore,
wherein the clearance control protrusion is configured for hydraulic forces exerted by pressurized fuel in the nozzle chamber against the outer surface prevents expansion of the portion of the clearance positioned within the clearance control protrusion.

2. The needle body of claim 1, wherein the clearance control protrusion is configured for generally inwardly directed hydraulic forces exerted on the outer surface to counter act hydraulic forces exerted against generally outwardly directed hydraulic forces exerted on the longitudinal bore.

3. The needle body of claim 1, wherein the clearance control protrusion has a cylindrical configuration.

4. The needle body of claim 1, wherein the outer surface of the clearance control protrusion is tapered so that a wall thickness of the clearance control protrusion between the outer surface and the longitudinal bore decreases as the clearance control protrusion extends away from the body portion.

5. The needle body of claim 1, wherein the clearance control protrusion is configured to at least partially bend, deform, or deflect from the hydraulic pressure of the pressurized fuel in the nozzle chamber so as to reduce the size of the clearance.

6. A needle body for the nozzle section of a high pressure fuel injector comprising:
a body portion;
a clearance control protrusion that extends from the body portion; and
a longitudinal bore that extends through the body portion and the clearance control protrusion, the clearance control protrusion being configured to control the size of the longitudinal bore along the clearance control protrusion when the needle body is subjected to hydraulic forces at operational fuel pressures in the nozzle chamber of a fuel injector.

7. The needle body of claim 6, wherein the clearance control protrusion controls the size of the longitudinal bore by reducing the size of at least a portion of the longitudinal bore.

8. The needle body of claim 7, wherein the clearance control protrusion is configured to at least partially bend, deform, or deflect when subjected to the hydraulic forces.

9. The needle body of claim 6, wherein the clearance control protrusion has a cylindrical configuration.

10. The needle body of claim 6, wherein the clearance control protrusion is tapered so that a wall thickness of the clearance control protrusion between an outer surface of the clearance control protrusion and the longitudinal bore decreases as the clearance control protrusion extends away from the body portion.

11. A system for controlling high pressure fuel leak in a fuel injector comprising:
a nozzle body having a nozzle chamber configured to receive and contain pressurized fuel;
a needle valve having a needle, the needle valve configured to release fuel from the nozzle chamber when the needle is moved from a closed position to an open position; and
a nozzle section having a body portion, a clearance control protrusion, and a longitudinal bore, the clearance control protrusion having an outer surface, the longitudinal bore configured to guide the movement of the needle as the needle moves between the closed and open positions, the longitudinal bore having a clearance between an inner wall of the longitudinal bore and an adjacent outer wall of the needle, the clearance control protrusion configured to prevent expansion of the clearance along the clearance control protrusion when the outer surface of the clearance control protrusion is subjected to hydraulic forces from the pressurized fuel.

12. The needle body of claim 11, wherein the clearance control protrusion is configured for generally inwardly directed hydraulic forces exerted on the outer surface to counter act hydraulic forces exerted against generally outwardly directed hydraulic forces exerted on the longitudinal bore.

13. The needle body of claim 11, wherein the clearance control protrusion has a cylindrical configuration.

14. The needle body of claim 11, wherein the outer surface of the clearance control protrusion is tapered so that a wall thickness of the clearance control protrusion between the outer surface and the longitudinal bore decreases as the clearance control protrusion extends away from the body portion.

15. The needle body of claim 11, wherein the clearance control protrusion is configured to at least partially bend, deform, or deflect from the hydraulic pressure of the pressurized fuel in the nozzle chamber so as to reduce the size of the clearance.
